(19) United States
(12) Patent Application Publication
(10) Pub. No.: US 2004/0025589 A1
(43) Pub. Date: Feb. 12, 2004

(54) Micromechanical component

(76) Inventors: Juergen Kurle, Reutlingen (DE); Kurt Weiblen, Metzingen (DE); Stefan Pinter, Reutlingen (DE)

Correspondence Address: Richard L Mayer, Kenyon & Kenyon, One Broadway, New York, NY, 10004, US

(21) Appl. No.: 10/343,788

(22) PCT Filed: Jul. 21, 2001
(86) PCT No.: PCT/DE01/02782

(30) Foreign Application Priority Data
Aug. 4, 2000 (DE) 100 38 099.9

(51) Int. Cl. G01P 15/00

(52) U.S. Cl. 73/488

(57) ABSTRACT

A micromechanical component includes a substrate and a movable structure situated on the surface of the substrate. The movable structure is movable parallel to the surface of the substrate. The structure is surrounded by a frame having a cap attached to it. In the area of the movable element, the cap has a stop limiting the movement of the movable element in a direction perpendicular to the surface of the substrate.

### BACKGROUND INFORMATION

There are already known micromechanical components in which movable structures are provided, these structures being movable parallel to the surface of the substrate. These structures are surrounded by a frame to which a cap is attached.

### SUMMARY OF THE INVENTION

The micromechanical component according to the present invention has the advantage over the related art that deflection of the movable element is limited in a direction perpendicular to the surface of the substrate. Excessive deflection of the movable element is prevented by this measure. This measure also increases the operational reliability of the micromechanical component.

The cap is produced especially easily by etching recesses into a wafer. A silicon wafer is especially suitable here. By additional coating in the area of the stop, it is possible to further reduce the deflection of the movable element. The connection of the cap to the frame is accomplished especially easily by additional layers. By introducing spacer beads, it is possible to accurately control the thickness of these connecting layers.

### BRIEF DESCRIPTION OF THE DRAWINGS

FIG. 1 shows a top view of a substrate.

FIG. 2 shows a cross section through a micromechanical component.

FIG. 3 shows a bottom view of a cap.

FIG. 4 shows a detailed view of a connecting area.

FIG. 5 shows another cross section through a micromechanical component.

### DETAILED DESCRIPTION

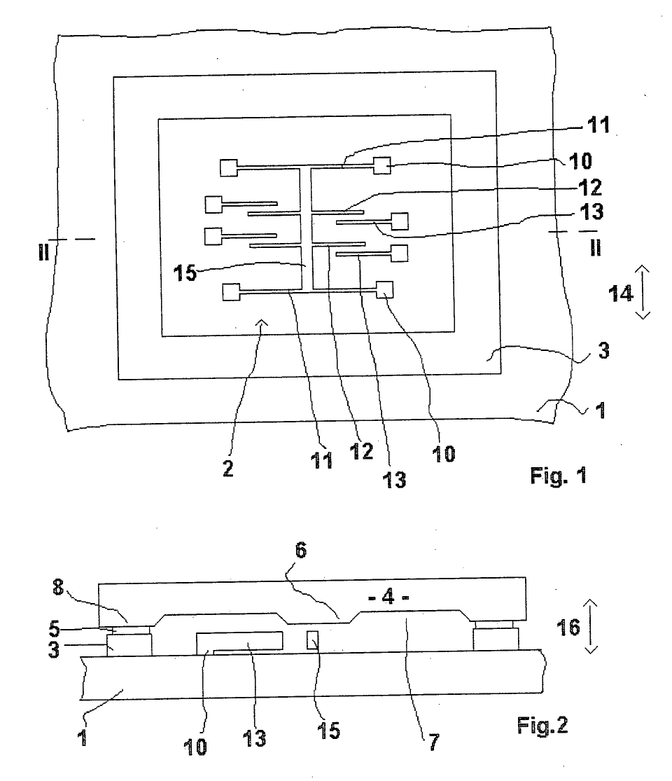

FIG. 1 shows a top view of a substrate 1 having a movable structure 2 situated on it. Substrate 1 is preferably a silicon substrate having a movable structure 2 of polysilicon situated on it. Movable structure 2 is fixedly connected to substrate 1 by anchoring blocks 10. Spiral springs 11 supporting a seismic mass 15 are attached to such anchoring blocks 10. Seismic mass 15 shown in FIG. 1 is attached to four anchoring blocks 10 by four spiral springs 11. Movable electrodes 12 are attached to seismic mass 15 and are situated approximately perpendicular to the elongated seismic mass 15. Stationary electrodes 13 are situated diametrically opposite movable electrodes 12 and are in turn fixedly connected to substrate 1 by anchoring blocks 10.

Movable structure 2 acts as an acceleration sensor whose measurement axis is indicated by arrow 14. In the case of an acceleration along axis 14, a force acts on seismic mass 15. Since seismic mass 15, spiral springs 11 and movable electrodes 12 are not attached to substrate 1, this results in a bending of spiral springs 11 due to this force acting on seismic mass 15, i.e., seismic mass 15 and accordingly thus also movable electrodes 12 are deflected in the direction of axis 14. This deflection is thus parallel to the surface of substrate 1. This deflection causes a change in the distance between movable electrodes 12 and stationary electrodes 13. If stationary electrodes 13 and movable electrodes 12 are used as a plate-type capacitor, deflection of the seismic mass may be detected by the change in capacitance between these two electrodes. Since this deflection is proportional to the prevailing acceleration along axis 14, it is possible for the device shown in FIG. 1 to measure the acceleration. The device shown in FIG. 1 is thus an acceleration sensor. However, the present invention is not limited to acceleration sensors, but instead may be used for any movable structure situated on the surface of a substrate 1.

Movable structure 2 on the surface of substrate 1 is surrounded by a frame 3. This frame 3 is provided as an anchor for a cap 4 (not shown in FIG. 1 to allow a view of movable structure 2). However, cap 4 is shown in FIG. 2. FIG. 2 shows a cross section through a micromechanical component which corresponds to a cross section along line II-II in FIG. 1. However, since cap 4 is not shown in FIG. 1, FIG. 2 corresponds to a cross section through FIG. 1 only with respect to substrate 1, frame 3 and movable structure 2.

FIG. 2 shows a cross section through substrate 1 having an anchoring block 10 mounted on it and a stationary electrode 13 mounted in turn on the latter. Stationary electrode 13 is connected here to substrate 1 only by anchoring block 10, so there remains an interspace between stationary electrode 13 and substrate 1. However, the geometric dimensions of stationary electrode 13 are such that there is negligibly little or no deflection of stationary electrode 13 due to acceleration along axis 14. The cross section of FIG. 2 also shows seismic mass 15, also at a distance from substrate 1. Seismic mass 15 is attached to the substrate only by spiral springs 11 and anchoring blocks 10 attached thereto, so that seismic mass 15 is able to move relative to the substrate. The mobility of seismic mass 15 relative to the substrate is determined by spiral springs 11. Spiral springs 11 are designed so that deflection occurs especially easily in the direction of acceleration axis 14. However, since spiral springs 11 are designed to be especially long, when there is a very strong acceleration there may also be a deflection in the direction of axis 16, as illustrated in FIG. 2, i.e., perpendicular to the substrate. If there is a strong acceleration along axis 16 and a component in the direction of axis 14 at the same time, there may be a very marked deflection, and in particular, movable electrodes 12 may come to lie on or behind the particular stationary electrodes 13, thus causing the structures to become mechanically stuck. To prevent such mechanical sticking, cap 4 is provided according to the present invention with a stop 6 which limits the deflection of seismic mass 15 along axis 16, i.e., perpendicular to the substrate.

FIG. 2 shows a cross section through cap 4 which is connected by connecting layers 5 to frame 3. A fixed connection between cap 4 and frame 3 is established by connecting layers 5, and in particular this makes it possible to establish an airtight connection between cap 4 and frame 3. This makes it possible to surround movable element 2 with a defined pressure. Stop 6 is provided in the area of seismic mass 15, i.e., in the area of movable structure 2. The other areas of cap 4 have a reduced thickness because recesses 7 are provided there. Cap 4 thus has its full thickness only in connecting area 8, where it is attached to frame 3, and in the area of stop 6, but the remaining areas are thinner due to recesses 7, so that in this area the distance between the micromechanical structures and cap 4 is greater. The volume of the air space in which the structure is enclosed is increased by recess 7. Process fluctuations which cause a variation in the distance between cap 4 and substrate 1 therefore result only in a slight change in the pressure of an enclosed gas.

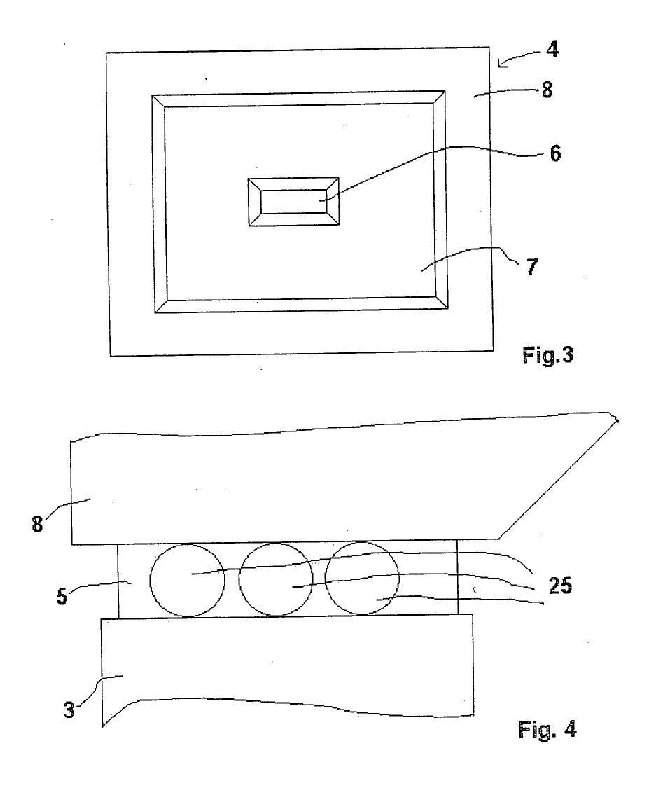

FIG. 3 shows a bottom view of cap 4. Cap 4 is designed to be approximately rectangular, with stop 6 being provided in a central area, completely surrounded by a recess 7. In the outer area of cap 4, there is a connecting area 8 which has approximately the same geometric dimensions as frame 3 in FIG. 1. This connecting area 8 is intended only for connecting to frame 3 by connecting layers 5.

As shown in the cross section in FIG. 2 and/or the bottom view in FIG. 3, the transitional areas between the outer edge of cap 4 and recess 7 and/or the transitional areas between stop 6 and recess 7 are designed as chamfers. This is due to the fact that a silicon substrate, which was machined by anisotropic etching, has been used as the example of a cap 4. Transitional chamfered areas are typically formed in anisotropic etching of silicon due to the crystal structure of the silicon wafer. However, all other types of materials are also conceivable for the covering plate, i.e., in addition to silicon, other materials such as glass, ceramic or the like may also be used. Then the glass or ceramic is structured with other etching processes, e.g., dry etching processes or other wet chemical etching methods accordingly.

In the example of FIGS. 1 through 3, cap 4 has the same thickness in its connecting area 8 and in the area of stop 6. The distance between stop 6 and seismic mass 15 is thus fixedly defined by the thickness of connecting layer 5.

FIG. 4 shows a method illustrating how the distance of connecting layer 5 between frame 3 and connecting area 8 of cap 4 is adjustable with a high precision. For this purpose, spacer beads 25 having a defined diameter are embedded in the material of connecting layer 5. Examples of the material for connecting layer 5 include adhesives or glass layers which are then fused. The thickness of the layer is then determined by the diameter of spacer beads 25.

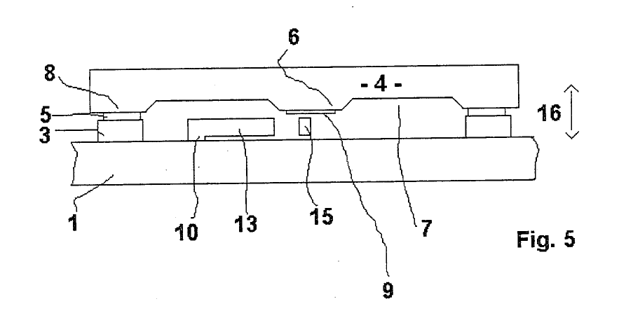

FIG. 5 shows another means suitable for influencing the distance between stop 6 and the movable element and/or seismic mass 15. An additional spacer layer 9 is provided in the area of stop 6 and is designed to be thinner than connecting layer 5. The distance between stop 6 and seismic mass 15 may thus be adjusted to have a lower value than the thickness of connecting layer 5. This procedure is advantageous when the thickness of connecting layer 5 is relatively great, in particular when the thickness of connecting layer 5 is greater than the thickness of movable structure 2 in the direction perpendicular to the substrate. Otherwise the micromechanical component shown in FIG. 5 corresponds to the design already illustrated in FIG. 2 and described on the basis of that figure. Additional layer 9 may be used in addition to spacer beads 25 in FIG. 4.

What is claimed is:

1. A micromechanical component comprising a substrate (1) and a movable structure (2), which is situated on the surface of the substrate (1) and is movable parallel to the surface of the substrate (1), the structure (2) being surrounded by a frame (3) situated on the surface of the substrate (1), and comprising a cap (4) which is attached to the frame (3) and extends over the movable structure (2), the cap (4) having a stop (6) in the area of the movable element (2) to limit movement of the movable element (2) in a direction perpendicular to the surface of the substrate (1),
wherein the cap (4) is provided by structuring out of a wafer, in particular a silicon wafer.

2. The micromechanical component as recited in claim 1,
wherein the cap (4) is formed by introducing at least one recess (7) into the wafer; the stop (6) and a connecting area (8) are defined by the recess (7), and the wafer out of which the cap (4) is structured has the same thickness in the stop (6) and in the region of the connecting area (8).

3. The micromechanical component as recited in one of the preceding claims,
wherein at least one additional layer (9) is applied to the cap (4) in the area of the stop (6) to adjust a distance between the stop (6) and the movable structure (2).

4. A component as recited in one of the preceding claims,
wherein the frame (3) is connected to the cap (4) by a connecting layer (5).

5. The component as recited in claim 4,
wherein spacer beads (25) having a defined diameter are provided in the connecting layer (5) to adjust the thickness of the connecting layer (5).
